(19) United States
(12) Patent Application Publication
(10) Pub. No.: US 2025/0141582 A1
(43) Pub. Date: May 1, 2025

(54) VARIABLE EQUALIZER, REPEATER, AND EQUALIZING METHOD INCORPORATION BY REFERENCE

(71) Applicant: NEC Corporation, Tokyo (JP)

(72) Inventor: Koji INADA, Tokyo (JP)

(73) Assignee: NEC Corporation, Tokyo (JP)

(21) Appl. No.: 18/910,640

(22) Filed: Oct. 9, 2024

(30) Foreign Application Priority Data
Oct. 31, 2023 (JP) 2023-186369

(51) Int. Cl. H04J 14/02

(52) U.S. Cl. CPC H04J 14/0212

(57) ABSTRACT

A variable equalizer, a repeater, and an equalizing method capable of reducing a cost incurred due to a plurality of equalizers which would otherwise need to be prepared according to the use conditions of the amplifier are provided. A variable equalizer includes an analysis unit configured to analyze a first spectrum of a wavelength-division multiplexed optical signal amplified by an amplifier, a control unit configured to calculate a loss profile indicating a loss for each wavelength based on the first spectrum so that a second spectrum of the wavelength-division multiplexed optical signal to which the loss profile is added becomes flat, and a WSS (Wavelength Selective Switch) configured to add the loss profile to the wavelength-division multiplexed optical signal.

### INCORPORATION BY REFERENCE

This application is based upon and claims the benefit of priority from Japanese patent application No. 2023-186369, filed on Oct. 31, 2023, the disclosure of which is incorporated herein in its entirety by reference.

### TECHNICAL FIELD

The present disclosure relates to a variable equalizer, a repeater, and an equalizing method.

### BACKGROUND ART

Patent Literature 1 discloses a technology related to an equalizer having a wide tilt-level adjustment range.

Patent Literature 1: International Patent Publication NO. WO2019/176894.

It should be noted that when the spectrum of a wavelength-division multiplexed optical signal amplified by an amplifier is not flat, an equalizer equalizes the gain of the wavelength-division multiplexed optical signal. The gain of an amplifier including an EDF (Erbium-Doped Fiber) or the like varies depending on the power of a wavelength-division multiplexed optical signal or the operating temperature of the amplifier. There has been a problem that a cost is incurred because a plurality of equalizers need to be prepared according to the conditions under which the amplifier is used (hereinafter also referred to as the use conditions of the amplifier).

The present disclosure has been made in view of the above-described problem, and an object thereof is to provide a variable equalizer, a repeater, and an equalizing method capable of reducing a cost incurred due to a plurality of equalizers which would otherwise need to be prepared according to the use conditions of the amplifier.

### SUMMARY

In order to achieve the above-described object, a variable equalizer according to the present disclosure includes:

an analysis unit configured to analyze a first spectrum of a wavelength-division multiplexed optical signal amplified by an amplifier;

a control unit configured to calculate a loss profile indicating a loss for each wavelength based on the first spectrum so that a second spectrum of the wavelength-division multiplexed optical signal to which the loss profile is added becomes flat; and

a WSS (Wavelength Selective Switch) configured to add the loss profile to the wavelength-division multiplexed optical signal.

In order to achieve the above-described object, a repeater according to the present disclosure includes:

an amplifier;

an analysis unit configured to analyze a first spectrum of a wavelength-division multiplexed optical signal amplified by the amplifier;

a control unit configured to calculate a loss profile indicating a loss for each wavelength based on the first spectrum so that a second spectrum of the wavelength-division multiplexed optical signal to which the loss profile is added becomes flat; and

a WSS (Wavelength Selective Switch) configured to add the loss profile to the wavelength-division multiplexed optical signal.

In order to achieve the above-described object, an equalizing method according to the present disclosure includes:

analyzing a first spectrum of a wavelength-division multiplexed optical signal amplified by an amplifier;

calculating a loss profile indicating a loss for each wavelength based on the first spectrum so that a second spectrum of the wavelength-division multiplexed optical signal to which the loss profile is added becomes flat; and

adding, by a WSS (Wavelength Selective Switch), the loss profile to the wavelength-division multiplexed optical signal.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram of a variable equalizer according to the present disclosure;

FIG. 2 is a block diagram of a repeater according to the present disclosure;

FIG. 3 is a flowchart of an equalizing method according to the present disclosure;

FIG. 4 is a diagram for explaining an initial state of a variable equalizer according to the present disclosure;

FIG. 5 is a diagram for explaining operations performed by a variable equalizer before a loss profile according to the present disclosure is set;

FIG. 6 is a diagram for explaining operations performed by the variable equalizer after the loss profile according to the present disclosure is set;

FIG. 7 is a diagram for explaining operations performed by an equalizer according to related art; and

FIG. 8 is a block diagram for explaining a hardware configuration of a variable equalizer or the like according to the present disclosure.

### EXAMPLE EMBODIMENT

### First Example Embodiment

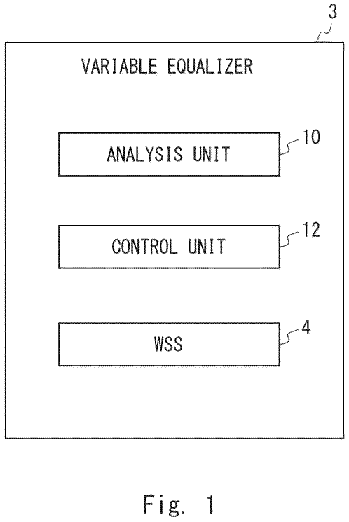

FIG. 1 shows an example of a configuration of a variable equalizer 3. The variable equalizer 3 includes an analysis unit 10, a control unit 12, and a WSS (Wavelength Selective Switch) 4. An amplifier (not shown) amplifies a wavelength-division multiplexed optical signal. The amplifier inputs (i.e., provides) the amplified wavelength-division multiplexed optical signal to the WSS 4.

The variable equalizer 3 may include a computer apparatus that operates by having a processor execute a program stored in a memory. The components or functions constituting the variable equalizer 3 may be distributed over a plurality of computer apparatuses. The analysis unit 10 and the control unit 12 may be software or modules by which processing is performed as a processor executing a program stored in a memory. Alternatively, the analysis unit 10 and the control unit 12 may be hardware such as a circuit or a chip.

The analysis unit 10 analyzes a spectrum (called a first spectrum) of the wavelength-division multiplexed optical signal amplified by the amplifier. The analysis unit 10 may use, for example, a part of the wavelength-division multiplexed optical signal that has passed through the WSS 4 for the analysis. Note that a part of the wavelength-division multiplexed optical signal may be extracted between the amplifier and the WSS 4. When a part of the wavelength-division multiplexed optical signal that has passed through the WSS 4 is used, the variable equalizer 3 can take an attenuation that is caused when the wavelength-division multiplexed optical signal passes through the WSS 4 into consideration.

The control unit 12 calculates a loss profile based on the first spectrum so that a spectrum (called a second spectrum) of the wavelength-division multiplexed optical signal to which the loss profile is added becomes flat. The loss profile indicates a loss for each wavelength.

The WSS 4 adds the loss profile calculated by the control unit 12 to the wavelength-division multiplexed optical signal. The spectrum of the wavelength-division multiplexed optical signal output from the WSS 4 becomes flat.

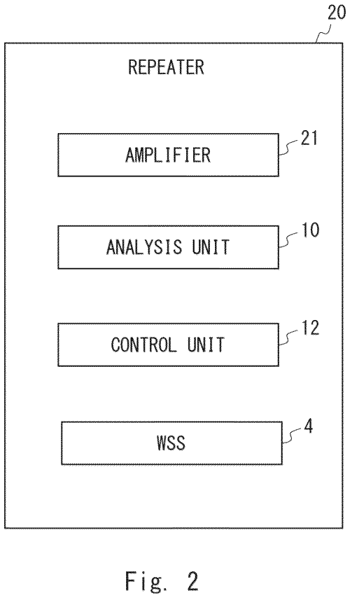

FIG. 2 shows an example of a configuration of a repeater 20. When FIGS. 1 and 2 are compared with each other, the repeater 20 further includes an amplifier 21 that amplifies the wavelength-division multiplexed optical signal.

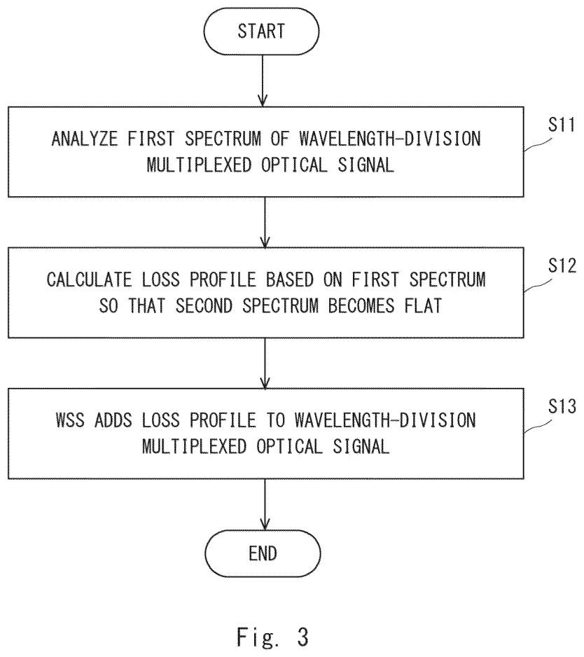

FIG. 3 shows an example of a flow of an equalizing method. Firstly, the analysis unit 10 of the variable equalizer 3 analyzes the first spectrum of the wavelength-division multiplexed optical signal amplified by the amplifier 21 (Step S11). Next, the control unit 12 of the variable equalizer 3 calculates a loss profile based on the first spectrum so that the second spectrum of the wavelength-division multiplexed optical signal to which the loss profile is added becomes flat (Step S12). Next, the WSS 4 of the variable equalizer 3 adds the loss profile to the wavelength-division multiplexed optical signal (Step S13).

Each of the variable equalizer 3, the repeater 20, and the equalizing method calculates a loss profile based on the result of the analysis of the first spectrum. Therefore, there is no need to set a loss profile corresponding to the use conditions of the amplifier in the equalizer in advance. Each of the variable equalizer 3, the repeater 20, and the equalizing method can reduce the cost incurred due to a plurality of equalizers which would otherwise need to be prepared according to the use conditions of the amplifier.

### Second Example Embodiment

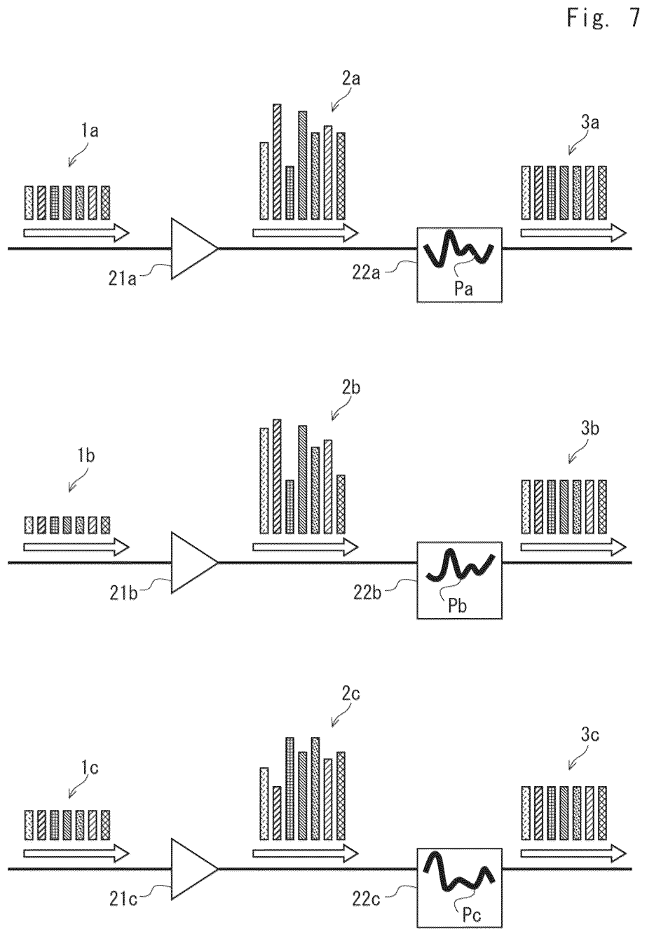

Operations performed by equalizers 22a to 22c according to related art will be described with reference to FIG. 7. Referring to the upper part of FIG. 7, an amplifier 21a amplifies a wavelength-division multiplexed optical signal 1a. The wavelength-division multiplexed optical signal la contains seven optical signals having wavelengths different from each other. The spectrum of the wavelength-division multiplexed optical signal 1a is flat. The amplifier 21a outputs the amplified wavelength-division multiplexed optical signal 1a as a wavelength-division multiplexed optical signal 2a. The amplifier 21a is equipped with an EDF. Since the gain of the EDF depends on the wavelength, the spectrum of the wavelength-division multiplexed optical signal 2a is not flat. In order to make the spectrum of a wavelength-division multiplexed optical signal 3a output from a repeater including the amplifier 21a flat, an equalizer 22a adds a loss profile Pa to the wavelength-division multiplexed optical signal 2a. The horizontal direction of the loss profile Pa corresponds to the wavelength, and the vertical direction thereof corresponds to the loss. As the amplifiers 21a, a plurality of amplifiers may be connected in a cascaded manner.

Referring to the middle part of FIG. 7, an amplifier 21b amplifies a wavelength-division multiplexed optical signal 1b and outputs the amplified wavelength-division multiplexed optical signal 1b as a wavelength-division multiplexed optical signal 2b. The optical intensity of the wavelength-division multiplexed optical signal 1a and that of the wavelength-division multiplexed optical signal 1b are different from each other. In this case, the spectrum of the wavelength-division multiplexed optical signal 2a and that of the wavelength-division multiplexed optical signal 2b are different from each other due to the characteristics of the EDF. In order to make the spectrum of a wavelength-division multiplexed optical signal 3b output from a repeater including the amplifier 21 flat, an equalizer 22b adds a loss profile Pb different from the loss profile Pa to the wavelength-division multiplexed optical signal 2b.

Referring to the lower part of FIG. 7, an amplifier 21c amplifies a wavelength-division multiplexed optical signal 1c and outputs the amplified wavelength-division multiplexed optical signal 1c as a wavelength-division multiplexed optical signal 2c. The optical intensity of the wavelength-division multiplexed optical signal la and that of the wavelength-division multiplexed optical signal 1c are equal to each other. Meanwhile, the operating temperature of the amplifier 21a and that of the amplifier 21c are different from each other. In this case, the spectrum of the wavelength-division multiplexed optical signal 2a and that of the wavelength-division multiplexed optical signal 2c are different from each other due to the characteristics of the EDF. In order to make the spectrum of a wavelength-division multiplexed optical signal 3c output from a repeater including the amplifier 21c flat, an equalizer 22c adds a loss profile Pc different from the loss profile Pa to the wavelength-division multiplexed optical signal 2c.

Therefore, when the related art is used, it is necessary to prepare a plurality of equalizers having loss profiles different from each other according to the optical intensity of the wavelength-division multiplexed optical signal or the operating temperature of the amplifier.

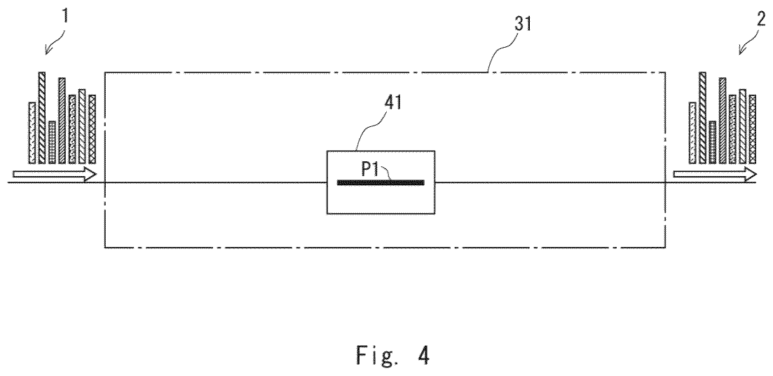

FIG. 4 is a diagram for explaining an initial state of a variable equalizer apparatus 31 according to the present disclosure. The variable equalizer apparatus 31 is a specific example of the variable equalizer 3 described above. A loss profile P1 set in a WSS module 41 is flat. The WSS module 41 is a specific example of the WSS 4 described above. A wavelength-division multiplexed optical signal 1 is input to the variable equalizer apparatus 31, and a wavelength-division multiplexed optical signal 2 is output from the variable equalizer apparatus 31. Each of the wavelength-division multiplexed optical signals 1 and 2 contains, for example, seven optical signals having wavelengths different from each other.

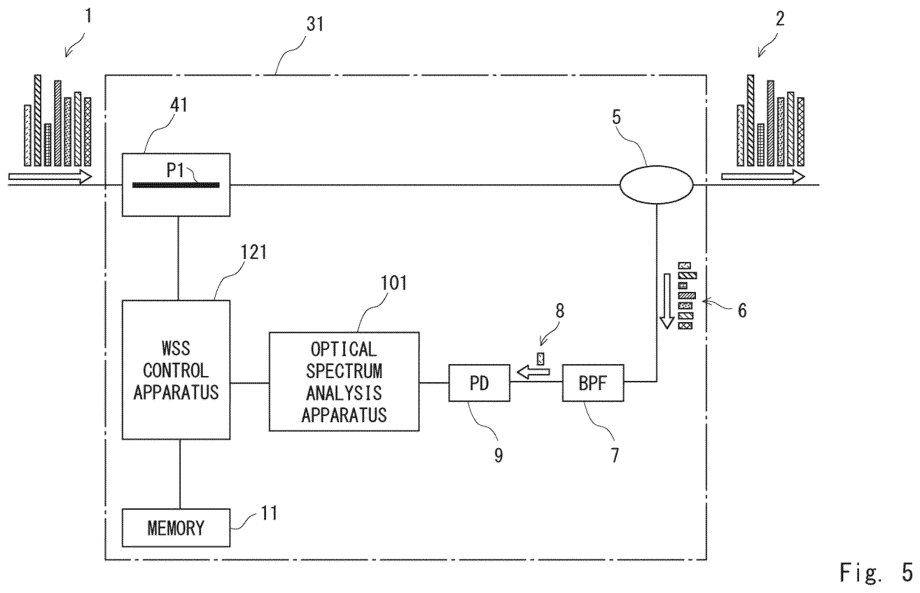

As shown in FIG. 5, from this initial state, an optical coupler 5 extracts a part of the wavelength-division multiplexed optical signal 1 that has passed through the WSS module 41 as a feedback signal 6. The optical coupler 5 is a 1×2 optical coupler. The remaining part of the wavelength-division multiplexed optical signal 1 is output from the variable equalizer apparatus 31 as the wavelength-division multiplexed optical signal 2.

The extracted feedback signal 6 passes through a BPF (Band Pass Filter) 7, and optical signals 8 (called wavelength components) having respective wavelengths 2 (e.g., having wavelengths λ1, λ2, λ3, λ4, λ5, λ6, and λ7, respectively,) are separated therefrom. The wavelengths λ1 to λ7 are different from each other. For example, each of seven BPFs 7 lets a respective one of the seven optical signals contained in the feedback signal 6 pass therethrough. PD (Photodetector) modules 9 receive these optical signals 8, respectively, and convert them into respective electrical signals. The PD modules may be, for example, photodiodes.

An optical spectrum analysis apparatus 101 calculates the optical intensities of the optical signals 8 based on the electrical signals. The optical spectrum analysis apparatus 101 is a specific example of the analysis unit 10 described above. The optical spectrum analysis apparatus 101 transmits the spectrum of the wavelength-division multiplexed optical signal 2 based on the optical intensities of the optical signals 8 to a WSS control apparatus 121.

The WSS control apparatus 121 calculates the loss profile of the WSS module 41 by using a target profile of the wavelength-division multiplexed optical signal 2 stored in advance in a memory 11 and the spectrum of the wavelength-division multiplexed optical signal 2 transmitted from the optical spectrum analysis apparatus 101. The target profile represents a target spectrum of the spectrum (second spectrum) of the wavelength-division multiplexed optical signal 2 to which the loss profile is added. The WSS control apparatus 121 is a specific example of the control unit 12 described above. The WSS control apparatus 121 transmits a control signal that is determined according to the loss profile to the WSS module 41.

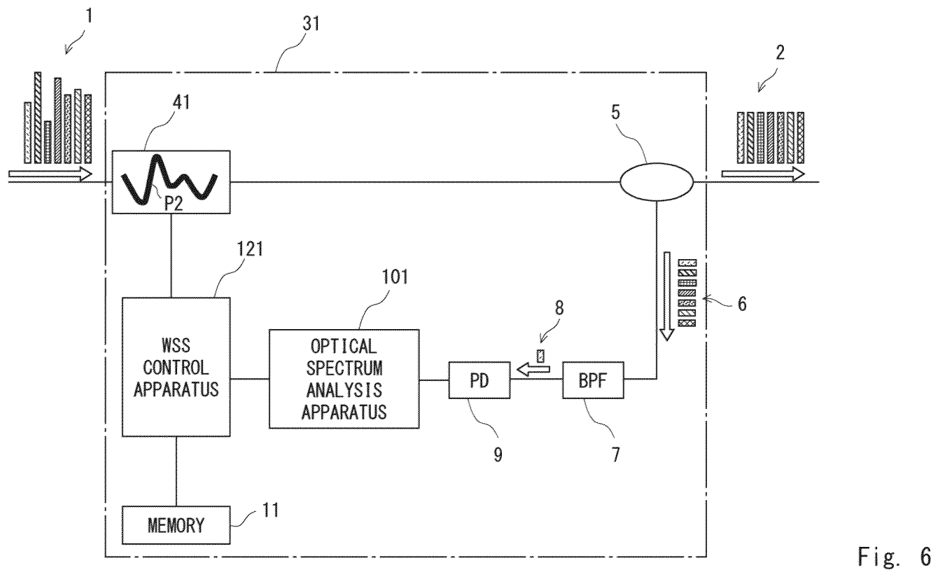

FIG. 6 shows a state after the WSS control apparatus 121 transmits the control signal to the WSS module 41. A loss profile P2 of the WSS module 41 is changed from the loss profile Pl shown in FIG. 5. As a result, the gain equalizing of the wavelength-division multiplexed optical signal 2 is performed. That is, the spectrum of the wavelength-division multiplexed optical signal 2 becomes flat.

The WSS module 41 is a module capable of changing the spectrum of an optical signal according to a control signal. The WSS module 41 is used in a ROADM (Reconfigurable Optical Add Drop Multiplexer) system or the like.

The WSS module 41 may include, for example, a splitter (or a demultiplexer), filters, optical switches, and a combiner (a multiplexer). The splitter (or the demultiplexer) splits (or demultiplexes), for example, the wavelength-division multiplexed optical signal 1 into seven optical signals. The filters filter optical signals having predetermined wavelengths according to a control signal. The optical switches switch the optical signals having predetermined wavelengths output from the corresponding filters. The combiner (or the multiplexer) combines (or multiplexes) the seven optical signals output from the seven optical switches and outputs the obtained signal as the wavelength-division multiplexed optical signal 2. In this case, as the filters operate according to the control signal, a loss profile is added to the wavelength-division multiplexed optical signal 1. Note that a component(s) other than the filters (e.g., an attenuator(s)) may add a loss profile to the wavelength-division multiplexed optical signal 1.

A repeater according to the second example embodiment makes it possible to, by using a variable equalizer, use the common equalizer (i.e., the variable equalizer) as equalizers required for gain equalizing, and thereby to reduce the time required to design the equalizer. Further, there is no need to change the equalizer when the cable is repaired or has deteriorated. As a result, the cost for designing the equalizer and for pulling up the equalizer from the seabed or the like can be reduced.

Recently, the use of submarine communication systems is increasing, and as a result, the following situation often occurs. That is, the operating temperatures of amplifiers may be different from one amplifier to another, and the optical intensities of wavelength-division multiplexed optical signals may be different from one wavelength-division multiplexed optical signal to another even within the same system. Regarding the characteristics of the EDF provided in a repeater used in such a system, the amplification level for each wavelength varies depending on the optical intensity or the signal band of the input wavelength-division multiplexed optical signal, or depending on the operating temperature of the repeater. Therefore, an equalizer module for equalizing a wavelength-division multiplexed optical signal used in such a system needs to be designed according to the specifications. Since the number of types of equalizer modules increases and a spare equalizer module(s) needs to be prepared for each of the types of equalizer modules, there has been a problem that the system price increases. The present disclosure reduces the number of types of equalizer modules to be used, and thus reducing the number of apparatuses to be manufactured. As a result, the system price decreases. Further, the variable equalizer can be commonly used in various systems in which different signal bands are used.

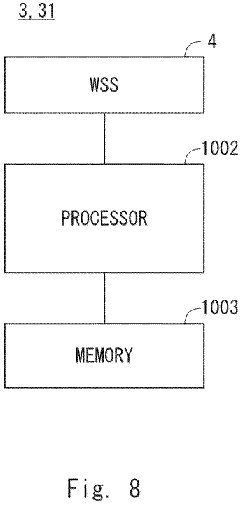

FIG. 8 is a block diagram showing an example of a hardware configuration of the variable equalizer 3 and the variable equalizer apparatus 31 (referred to as the variable equalizer 3 or the like) described in the above-described example embodiments. As shown in FIG. 8, the variable equalizer 3 or the like includes a WSS 4, a processor 1002, and a memory 1003.

The processor 1002 loads software (a computer program) from the memory 1003 and executes the loaded software, so that the processor 1002 performs the processes in the steps S11 and S12 shown in FIG. 3. The processor 1002 may be, for example, a microprocessor, an MPU, or a CPU. The processor 1002 may include a plurality of processors.

The memory 1003 is composed of a combination of a volatile memory and a nonvolatile memory. The memory 1003 may include a storage remotely located from the processor 1002. In this case, the processor 1002 may access the memory 1003 through an I/O (Input/Output) interface (not shown).

In the example shown in FIG. 3, the memory 1003 is used to store a group of software modules. The processor 1002 loads the group of software modules from the memory 1003 and executes the loaded software modules, so that the processor 1002 can perform the processes in the steps S11 and S12.

As described above with reference to FIG. 8, each of the processors included in the variable equalizer in the above-described example embodiment executes one or a plurality of programs including a set of instructions for causing a computer to perform the algorithm described above with reference to the drawings.

In the above-described examples, the program includes a set of instructions (or software codes) that, when read into a computer, causes the computer to perform one or more of the functions described in the example embodiments. The program may be stored in a non-transitory computer readable medium or in a physical storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disc (DVD), a Blu-ray (registered trademark) disc or other optical disc storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

Note that the technical ideas in the present disclosure are not limited to the above-described example embodiments, and they may be modified as appropriate without departing from the scope and spirit of the disclosure.

Although the present disclosure is described above with reference to example embodiments, the present disclosure is not limited to the above-described example embodiments. Various modifications that can be understood by those skilled in the art can be made to the configuration and details of the present disclosure within the scope and spirit of the disclosure. Further, the example embodiments may be combined with one another as appropriate.

Each of the drawings is merely an example to illustrate one or more embodiments. Each of the drawing is not associated with only one specific embodiment, but may be associated with one or more other embodiments. As will be understood by those skilled in the art, various features or steps described with reference to any one of the drawings may be combined with features or steps shown in one or more other drawings in order to create, for example, an embodiment that is not explicitly shown in the drawings or described in the specification. Not all of the features or steps shown in any one of the drawings to describe an embodiment are necessarily indispensable, and some features or steps may be omitted. The order of steps in any of the drawings may be changed as appropriate.

Further, the whole or part of the example embodiments disclosed above can be described as, but not limited to, the following supplementary notes.

Some or all of the elements (e.g., structures and functions) described in Supplementary notes 2 to 5 that are dependent on Supplementary note 1 can be dependent on Supplementary notes 6 and 10 by the same dependency relationships as those in Supplementary notes 2 to 5. Some or all of the elements described in any of the supplementary notes can be applied to various types of hardware, software, recording means for recording software, systems, and methods.

### Supplementary Note 1

A variable equalizer comprising:

an analysis unit configured to analyze a first spectrum of a wavelength-division multiplexed optical signal amplified by an amplifier;

a control unit configured to calculate a loss profile indicating a loss for each wavelength based on the first spectrum so that a second spectrum of the wavelength-division multiplexed optical signal to which the loss profile is added becomes flat; and

a WSS (Wavelength Selective Switch) configured to add the loss profile to the wavelength-division multiplexed optical signal.

### Supplementary Note 2

The variable equalizer described in Supplementary note 1, further comprising a memory configured to store a target profile of the second spectrum, wherein

the control unit calculates the loss profile based also on the target profile.

### Supplementary Note 3

The variable equalizer described in Supplementary note 2, further comprising an optical coupler configured to extract a part of the wavelength-division multiplexed optical signal that has passed through the WSS as a feedback signal, wherein

the analysis unit analyzes the first spectrum by using the feedback signal.

### Supplementary Note 4

The variable equalizer described in Supplementary note 3, further comprising:

a plurality of BPFs (Band Pass Filters) through which a plurality of optical signals having wavelengths different from each other, contained in the feedback signal, are respectively transmitted; and

a plurality of PD (Photodetector) modules configured to respectively receive the plurality of optical signals that have passed through the respective BPFs, and convert the received optical signals into electrical signals, wherein

the analysis unit analyzes the first spectrum based on the electric signals.

### Supplementary Note 5

The variable equalizer described in Supplementary note 1 or 2, wherein the amplifier comprises an EDF (Erbium Doped Fiber).

### Supplementary Note 6

A repeater comprising:

an amplifier;

an analysis unit configured to analyze a first spectrum of a wavelength-division multiplexed optical signal amplified by the amplifier;

a control unit configured to calculate a loss profile indicating a loss for each wavelength based on the first spectrum so that a second spectrum of the wavelength-division multiplexed optical signal to which the loss profile is added becomes flat; and

a WSS (Wavelength Selective Switch) configured to add the loss profile to the wavelength-division multiplexed optical signal.

### Supplementary Note 7

The repeater described in Supplementary note 6, further comprising a memory configured to store a target profile of the second spectrum, wherein the control unit calculates the loss profile based also on the target profile.

### Supplementary Note 8

The repeater described in Supplementary note 7, further comprising an optical coupler configured to extract a part of the wavelength-division multiplexed optical signal that has passed through the WSS as a feedback signal, wherein

the analysis unit analyzes the first spectrum by using the feedback signal.

### Supplementary Note 9

The repeater described in Supplementary note 8, further comprising:

a plurality of BPFs (Band Pass Filters) through which a plurality of optical signals having wavelengths different from each other, contained in the feedback signal, are respectively transmitted; and

a plurality of PD (Photodetector) modules configured to respectively receive the plurality of optical signals that have passed through the respective BPFs, and convert the received optical signals into electrical signals, wherein the analysis unit analyzes the first spectrum based on the electric signals.

### Supplementary Note 10

An equalizing method comprising:

analyzing a first spectrum of a wavelength-division multiplexed optical signal amplified by an amplifier;

calculating a loss profile indicating a loss for each wavelength based on the first spectrum so that a second spectrum of the wavelength-division multiplexed optical signal to which the loss profile is added becomes flat; and

adding, by a WSS (Wavelength Selective Switch), the loss profile to the wavelength-division multiplexed optical signal.

According to the above-described aspect of the present disclosure, it is possible to reduce a cost incurred due to a plurality of equalizers which would otherwise need to be prepared according to the use conditions of the amplifier.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. A variable equalizer comprising:
an analysis unit configured to analyze a first spectrum of a wavelength-division multiplexed optical signal amplified by an amplifier;
a control unit configured to calculate a loss profile indicating a loss for each wavelength based on the first spectrum so that a second spectrum of the wavelength-division multiplexed optical signal to which the loss profile is added becomes flat; and
a WSS (Wavelength Selective Switch) configured to add the loss profile to the wavelength-division multiplexed optical signal.

2. The variable equalizer according to claim 1, further comprising a memory configured to store a target profile of the second spectrum, wherein
the control unit calculates the loss profile based also on the target profile.

3. The variable equalizer according to claim 2, further comprising an optical coupler configured to extract a part of the wavelength-division multiplexed optical signal that has passed through the WSS as a feedback signal, wherein
the analysis unit analyzes the first spectrum by using the feedback signal.

4. The variable equalizer according to claim 3, further comprising:
a plurality of BPFs (Band Pass Filters) through which a plurality of optical signals having wavelengths different from each other, contained in the feedback signal, are respectively transmitted; and
a plurality of PD (Photodetector) modules configured to respectively receive the plurality of optical signals that have passed through the respective BPFs, and convert the received optical signals into electrical signals, wherein
the analysis unit analyzes the first spectrum based on the electric signals.

5. The variable equalizer according to claim 1, wherein the amplifier comprises an EDF (Erbium Doped Fiber).

6. A repeater comprising:
an amplifier;
an analysis unit configured to analyze a first spectrum of a wavelength-division multiplexed optical signal amplified by the amplifier;
a control unit configured to calculate a loss profile indicating a loss for each wavelength based on the first spectrum so that a second spectrum of the wavelength-division multiplexed optical signal to which the loss profile is added becomes flat; and
a WSS (Wavelength Selective Switch) configured to add the loss profile to the wavelength-division multiplexed optical signal.

7. The repeater according to claim 6, further comprising a memory configured to store a target profile of the second spectrum, wherein
the control unit calculates the loss profile based also on the target profile.

8. The repeater according to claim 7, further comprising an optical coupler configured to extract a part of the wavelength-division multiplexed optical signal that has passed through the WSS as a feedback signal, wherein
the analysis unit analyzes the first spectrum by using the feedback signal.

9. The repeater according to claim 8, further comprising:
a plurality of BPFs (Band Pass Filters) through which a plurality of optical signals having wavelengths different from each other, contained in the feedback signal, are respectively transmitted; and
a plurality of PD (Photodetector) modules configured to respectively receive the plurality of optical signals that have passed through the respective BPFs, and convert the received optical signals into electrical signals, wherein
the analysis unit analyzes the first spectrum based on the electric signals.

10. An equalizing method comprising:
analyzing a first spectrum of a wavelength-division multiplexed optical signal amplified by an amplifier;
calculating a loss profile indicating a loss for each wavelength based on the first spectrum so that a second spectrum of the wavelength-division multiplexed optical signal to which the loss profile is added becomes flat; and
adding, by a WSS (Wavelength Selective Switch), the loss profile to the wavelength-division multiplexed optical signal.
